(19) United States
(12) Patent Application Publication
(10) Pub. No.: US 2024/0122181 A1
(43) Pub. Date: Apr. 18, 2024

(54) STABLE FUNGICIDAL COMPOSITIONS

(71) Applicants: UPL Corporation Limited, Port Louis (MU); UPL Europe LTD, Warrington (GB)

(72) Inventors: Pardeep Kaur, Evesham (GB); Dev Varta Mukherjee, Mumbai (IN); Charles Flood, Evesham (GB)

(21) Appl. No.: 18/546,518

(22) PCT Filed: Feb. 15, 2022
(86) PCT No.: PCT/GB2022/050400

§ 371 Date: Aug. 15, 2023

(30) Foreign Application Priority Data
Feb. 16, 2021 (GB) 2102142.3

(51) Int. Cl. A01N 43/653; A01N 25/30; A01P 3/00

(52) U.S. Cl. CPC A01N 43/653; A01N 25/30; A01P 3/00

(57) ABSTRACT

A stable agrochemical composition comprising at least one conazole fungicide, especially triticonazole and prothio-conazole; and at least one anionic surfactant is disclosed. Also disclosed is a process of preparing the agrochemical composition and a method of controlling fungi in a plant with the agrochemical composition.

### FIELD OF THE DISCLOSURE

The present disclosure relates to a fungicidal composition, and in particular, to a liquid 5 fungicidal composition comprising a conazole compound. A process of preparing the fungicidal composition and a method of controlling fungi in a plant using the agrochemical composition are also disclosed.

### BACKGROUND OF THE DISCLOSURE

Fungicides are an integral and important tool wielded by farmers to control fungal diseases in plants by inhibiting or killing the fungi causing the diseases.

The fungicide 1,2,4-triazole and its derivatives represent a biologically active class of compounds, possessing a wide spectrum of activities. These triazole fungicides are economically important agrochemicals as they are widely used on crops such as wheat, barley, soybean, and orchard fruits, and have protective, curative and eradicant properties. A conazole is a triazole fungicide of particular importance, an example of which is prothioconazole (2-[2-(1-chlorocyclopropyl)-3-(2-chlorophen-yl)-2-hydroxypropyl]-2, 4-dihydro-[1,2,4-]-trazole-3-thione). Prothioconazole is a sterol demethylation inhibitor, which targets the biosynthesis pathway for ergosterol, and is used to control fungal growth in agricultural applications.

Formulations comprising a conazole become unstable during storage or during application when diluted with water due to selection unsuitable inactive ingredients.

There thus remains a need to develop liquid compositions including a conazole fungicidal compound that remain stable over the duration of their shelf life and during application of the composition following dilution with water.

### Objectives of the Disclosure

An objective of the present disclosure is to provide an agrochemical composition comprising a conazole fungicide and at least one anionic surfactant.

An objective of the present disclosure is to provide a process of preparing an agrochemical composition comprising a conazole fungicide and at least one anionic surfactant.

Another objective of the present disclosure is to provide an agrochemical liquid composition comprising a conazole fungicide and at least one anionic surfactant.

Another objective of the present disclosure is to provide a process of preparing an agrochemical liquid composition comprising a conazole fungicide and at least one anionic surfactant.

Yet another objective of the present disclosure is to provide an agrochemical liquid composition comprising prothioconazole and at least one anionic surfactant.

Yet another objective of the present disclosure is to provide an agrochemical liquid composition comprising triticonazole and at least one anionic surfactant.

Yet another objective of the present disclosure is to provide a method of controlling fungi comprising applying, to the plant or to the locus at which the plant is growing or intended to be grown or to the plant propagation material, an agrochemical fungicidal composition comprising a conazole fungicide and at least one anionic surfactant.

Yet another objective of the present disclosure is to provide an agrochemical liquid composition comprising prothioconazole and/or triticonazole, at least one additional fungicide and at least one anionic surfactant.

### SUMMARY OF THE DISCLOSURE

In an aspect, the present disclosure provides an agrochemical fungicidal composition comprising a conazole fungicide, or a salt, an ester, an isomer thereof and at least one anionic surfactant.

In an aspect, the agrochemical fungicidal composition is a liquid composition.

In an aspect, the present disclosure provides an agrochemical fungicidal composition comprising a conazole fungicide, or a salt, an ester, an isomer thereof, an additional fungicide, and at least one anionic surfactant.

In yet another aspect, the present disclosure provides a process of preparing the disclosed agrochemical fungicidal compositions.

In yet another aspect, the present disclosure provides a method of controlling fungi in a plant comprising applying to the plant, the plant propagation material thereof, or to the locus at which the plant is growing or intended to be grown, an agrochemical fungicidal composition comprising a conazole fungicide and an anionic surfactant.

In an embodiment, the plant propagation material is a seed.

### DETAILED DESCRIPTION

For the purposes of the following detailed description, it is to be understood that the disclosure may assume various alternative variations except where expressly specified to the contrary. Moreover, other than in any operating examples, or where otherwise indicated, all numbers expressing, for example, quantities of materials/ingredients used in the specification are to be understood as being modified in all instances by the term “about”.

Unless otherwise defined, all technical and scientific terms used herein have the same meaning as commonly understood by one of ordinary skill in the art to which this disclosure pertains. In the case of conflict, the present document, including definitions will control.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

As used herein, “a,” “an,” “the,” and “at least one” do not denote a limitation of quantity and are intended to cover both the singular and plural, unless the context clearly indicates otherwise. For example, “an element” has the same meaning as “at least one element,” unless the context clearly indicates otherwise. The terms first, second etc. as used herein are not meant to denote any particular ordering, but simply for convenience to denote a plurality of, for example, layers. As used herein, the terms “comprising” “including,” “having,” “containing,” “involving,” and the like are to be understood to be open-ended, i.e., to mean “including” but not limited to, unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10% or +5% of the stated value. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

In any aspect or embodiment described hereinbelow, the phrase comprising may be replaced by the phrases “consisting of” or “consisting essentially of” or “consisting substantially of”. In these aspects or embodiment, the composition described includes or comprises, or consists of, or consists essentially of, or consists substantially of the specific components recited therein, to the exclusion of other ingredients or excipients not specifically recited therein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context.

“Alkyl” means a straight or branched chain saturated aliphatic hydrocarbon having the specified number of carbon atoms, specifically 1 to 12 carbon atoms, more specifically 1 to 6 carbon atoms. Alkyl groups include, for example, groups having from 1 to 50 carbon atoms (C1 to C50 alkyl).

“Aryl” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof.

“Alkylene” means a straight or branched chain, saturated, divalent aliphatic hydrocarbon group, (e.g., methylene (—CH2-) or, propylene (—(CH2)3-)).

As used throughout the disclosure, the conazole fungicide or other active ingredients, includes their salts, esters, ethers, isomers, and polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods. A “solvate” means the fungicide or its pharmaceutically acceptable salt, wherein molecules of a suitable solvent are incorporated in the crystal lattice. A suitable solvent is physiologically tolerable at the dosage administered. Examples of suitable solvents are ethanol, water and the like. When water is the solvent, the molecule is referred to as a “hydrate”. The formation of solvates will vary depending on the compound and the solvate. In general, solvates are formed by dissolving the compound in the appropriate solvent and isolating the solvate by cooling or using an antisolvent. The solvate is typically dried or azeotroped under ambient conditions. In an aspect, the solvate is a hydrate.

The term “plant” refers to all physical parts of a plant, including seeds, seedlings, saplings, roots, tubers, stems, stalks, foliage and fruits. The term plant includes transgenic and non-transgenic plants.

The term “locus” as used herein refers to the vicinity, area, or place in which the plants are growing, where plant propagation materials of the plants are sown (e.g., placed into the soil), and/or where the plant propagation materials of the plants will be sown.

The term “plant propagation material” refers to the generative parts of a plant, such as seeds, vegetative material such as cuttings or tubers, roots, fruits, tubers, bulbs, rhizomes, and other parts of plants, germinated plants, and/or young plants, which are to be transplanted after germination or after emergence from the soil. These young plants may be protected prior to transplantation by a total or partial immersion treatment/system.

As used herein, “effective amount” is an amount of active ingredient, such as the disclosed combinations, which has an adverse effect on a fungus and/or which prevents a fungal disease in a plant. The adverse effect can include killing of the fungus (fungicidal), preventing growth of the fungus, blocking of biosynthetic pathway(s), or a combination thereof.

As used herein, an “agriculturally acceptable salt” means a salt which is known and accepted for use in agricultural or horticultural use.

“Phytotoxicity” refers to a toxic (negative) effect on the growth of a plant.

It has been surprisingly and advantageously discovered that an anionic surfactant provides stability to compositions comprising a conazole fungicide.

The thickening of liquid fungicidal compositions which occurs during storage renders the fungicidal compositions unsuitable for use, thus there is a need to solve this problem and obtain a liquid agrochemical fungicidal composition which is not prone to thickening. In an attempt to make an agrochemical fungicidal formulation, it has been advantageously found that an anionic surfactant provides a breakthrough in solving the problems associated with liquid agrochemical fungicidal compositions. In particular, the inventors have developed a fungicidal composition having improved stability on storage, and which notably does not demonstrate a significant viscosity increase after 2 weeks at 54° C., 1 month at 50° C., and/or 8 weeks at 40° C., for example. The present disclosure therefore provides agrochemical fungicidal formulations which retain agrochemical viscosity during storage thereby enabling improved pourability.

According to an aspect of the present disclosure, provided is an agrochemical fungicidal composition comprising:
a) at least one conazole fungicide or a salt, an ester, an isomer thereof; and
b) an anionic surfactant.

According to an aspect of the present disclosure, provided is an agrochemical fungicidal composition comprising:
a) at least one conazole fungicide or a salt, an ester, an isomer thereof
b) an anionic surfactant; and
c) optionally other adjuvants.

In an aspect, the agrochemical fungicidal composition is a liquid agrochemical fungicidal composition.

According to an embodiment, the conazole fungicide comprises azaconazole, bromuconazole, cyproconazole, diclobutrazol, difenoconazole, diniconazole, diniconazole-M, epoxiconazole, etaconazole, fenbuconazole, fluconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, thiabendazole, triadimefon, triadimenol, triticonazole, uniconazole and uniconazole-P, a salt, an ester, an isomer thereof, or a combination thereof.

According to an aspect, the conazole fungicide comprises prothioconazole or a salt, an ester, an isomer thereof.

According to an aspect, the conazole fungicide comprises triticonazole or a salt, an ester, an isomer thereof.

In an embodiment, the composition comprises from about 0.01% to about 50% w/w of the conazole fungicide, based on the total weight of the fungicidal composition.

In an embodiment, the composition comprises from about 0.01% to about 30% w/w of the conazole fungicide, based on the total weight of the fungicidal composition.

In an embodiment, the composition comprises from about 1% to about 30% w/w of the conazole fungicide, based on the total weight of the fungicidal composition.

In an embodiment, the anionic surfactant comprises an alkyl ether salt such as an alkyl ether sulfate, an alkyl ether phosphate, or a combination thereof. Examples of the alkyl ether salt include, for example, an alkylaryl ether sulfate, a polyarylphenol polyalkoxyether sulfate, a polyarylphenol polyalkoxyether phosphate, or a combination thereof.

In an embodiment, the anionic surfactant comprises an alkyl ether sulphate, an alkyl ether phosphate, a salt thereof, or a combination thereof. In an embodiment the anionic surfactant comprises a C₁₀ to C₂₀ alkyl ether sulphate, a C₁₀ to C₂₀ alkyl ether phosphate, or a combination thereof. Examples include a sodium alkyl ether sulfate, a polyoxyalkyene alkylether sulfate, a polyoxyalkylene alkylaryl ether sulfate, an alkyl phosphate, for example potassium isotridecyl ether phosphate, potassium salt of tridecyl alcohol ether phosphate, polyoxyalkylene alkyl phosphates, polyoxyalkylene phenylether phosphate, and a combination thereof.

In an embodiment the anionic surfactant comprises sodium isotridecyl ether sulfate having 20 ethylene oxide (EO) units, a C₁₂₋₁₄ ether sulfate having 7 EO units, potassium isotridecyl ether phosphate, or a combination thereof.

In an embodiment the compositions comprise from about 0.1 to about 99.9% by weight of the anionic surfactant.

In an embodiment the compositions comprise from about 0.1 to about 99.9%, by weight of the alkyl ether sulfate and/or the alkyl ether phosphate, based on the total weight of the fungicidal composition.

In an embodiment the compositions comprise from about 2 to about 70%, by weight of the alkyl ether sulfate and/or the alkyl ether phosphate, based on the total weight of the fungicidal composition.

In an embodiment the compositions comprise from about 5 to about 60%, by weight of the alkyl ether sulfate and/or the alkyl ether phosphate, based on the total weight of the fungicidal composition.

In an embodiment of the present disclosure, the ratio of the at least one conazole fungicidal compound to the anionic surfactant is in the range from about 1:10 to about 10:1, or about 1:1 to about 10:1, or about 2:1 to about 5:1. Unless otherwise indicated, all ratios referred to herein are weight ratios.

In an embodiment of the present disclosure, the ratio of the at least one conazole fungicidal compound to the anionic surfactant is in the range from about 1:1 to about 10:1. Unless otherwise indicated, all ratios referred to herein are weight ratios.

In an embodiment of the present disclosure, the ratio of the at least one conazole fungicidal compound to the anionic surfactant is in the range from about 2:1 to about 5:1. Unless otherwise indicated, all ratios referred to herein are weight ratios.

The disclosed fungicidal compositions are particularly advantageous for the treatment of plant propagation materials, and in particular, for the treatment of seeds. In particular, fungicidal compositions comprising at least one of tebuconazole, cyproconazole, diphenoconazole, diniconazole, triticonazole, hexaconazole, triflumiazole, mectonazole, tricilazole, prothioconazole, flusilazole, flutriafol and mycobutanil can be beneficially applied to a plant propagation material.

In an embodiment, the present agrochemical fungicidal composition comprises:
a) prothioconazole or a salt, an ester, an isomer thereof; and
b) an anionic surfactant.

In an embodiment, the present agrochemical fungicidal composition comprises:
a) triticonazole, or a salt, an ester, an isomer thereof; and
b) an anionic surfactant.

In an embodiment, the anionic surfactant comprises an alkyl ether sulphate, an alkyl ether phosphate, or a combination thereof.

In an embodiment, the disclosed agrochemical fungicidal composition further comprises at least one agrochemically acceptable excipient.

In an embodiment, the present agrochemical fungicidal composition comprises:
a) triticonazole; and
b) an anionic surfactant.

In an embodiment, the present agrochemical fungicidal composition comprises:
a) triticonazole; and
b) an anionic surfactant selected from alkyl ether sulphate or alkyl ether phosphate.

According to an embodiment of the present disclosure, provided is, a process of preparing an agrochemical fungicidal composition, comprising: obtaining a mixture of at least one conazole fungicide or a salt, an ester, an isomer thereof, an anionic surfactant, and optionally other adjuvants; milling the mixture; and combining the milled mixture with a solvent to obtain the agrochemical composition, wherein the agrochemical composition comprises: the at least one conazole fungicide or a salt, an ester, an isomer thereof the anionic surfactant; and optionally the other adjuvants.

In an embodiment, the solvent used in the process of preparation is water.

According to an embodiment of the present disclosure, provided is, a process of preparing an agrochemical fungicidal composition, comprising: obtaining a mixture of at least one conazole fungicide or a salt, an ester, an isomer thereof, an anionic surfactant, an additional fungicide, and optionally other adjuvants; milling the mixture; and combining the milled mixture with a solvent to obtain the agrochemical composition, wherein the agrochemical composition comprises: the at least one conazole fungicide or a salt, an ester, an isomer thereof; the anionic surfactant; the additional fungicide; and optionally the other adjuvants.

In an embodiment, the solvent used in the process of preparation is water.

In an embodiment, the combining of the milled mixture of the at least one conazole fungicide or a salt, an ester, an isomer thereof, the anionic surfactant, and optionally the other adjuvants and the solvent is done at a speed between 6000-8000 rpm.

According to an embodiment of the present disclosure, provided is, a process of preparing an agrochemical fungicidal composition, comprising: obtaining a mixture of prothioconazole, an anionic surfactant, and optionally other adjuvants; milling the mixture; and combining the milled mixture with a solvent to obtain the agrochemical composition, wherein the agrochemical composition comprises prothioconazole or a salt, an ester, an isomer thereof; the anionic surfactant; and optionally the other adjuvants.

According to an embodiment of the present disclosure, provided is, a process of preparing an agrochemical fungicidal composition, comprising, obtaining a mixture of prothioconazole, an anionic surfactant, fludioxonil and optionally other adjuvants, milling the mixture and combining the milled mixture with a solvent to obtain the agrochemical composition, wherein the agrochemical composition comprises prothioconazole or a salt, an ester, an isomer thereof; the anionic surfactant; fludioxonil; and optionally the other adjuvants.

According to an embodiment of the present disclosure, provided is, a process of preparing an agrochemical fungicidal composition, comprising, obtaining a mixture of triticonazole, an anionic surfactant, and optionally other adjuvants, milling the mixture and combining the milled mixture with a solvent to obtain the agrochemical composition, wherein the agrochemical composition comprises: triticonazole or a salt, an ester, an isomer thereof; the anionic surfactant; and optionally the other adjuvants.

According to an embodiment of the present disclosure, provided is, a process of preparing an agrochemical fungicidal composition, comprising, obtaining a mixture of triticonazole, an anionic surfactant, fludioxonil and optionally other adjuvants, milling the mixture and combining the milled mixture with a solvent to obtain the agrochemical composition, wherein the agrochemical composition comprises triticonazole or a salt, an ester, an isomer thereof the anionic surfactant; fludioxonil; and optionally the other adjuvants.

In an embodiment, the disclosed fungicidal compositions further comprise at least one additional fungicide, and optionally, an agrochemically acceptable excipient.

Accordingly, in an embodiment, the present disclosure provides an agrochemical fungicidal composition comprising:
a) at least one conazole fungicide;
b) an anionic surfactant; and
c) at least one additional fungicide.

Non-limiting examples of the additional fungicide, comprise dithiocarbamate fungicides, demethylation inhibitors, quinone outside inhibitors, succinate dehydrogenase inhibitors, quinone inside inhibitors, or a combination thereof.

According to an embodiment, the strobilurin fungicide comprises azoxystrobin, kresoxim-methyl, picoxystrobin, pyraclostrobin, trifloxystrobin, or a combination thereof.

In an embodiment, the dithiocarbamate fungicides comprise amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb, zineb, or a combination thereof.

In an embodiment, the dithiocarbamate fungicide comprises mancozeb.

In an embodiment, the quinone outside inhibitor comprises a strobilurin fungicides.

The strobilurin fungicide includes, for example, fluoxastrobin, mandestrobin, pyribencarb; methoxyacrylate strobilurin fungicides selected from azoxystrobin, bifujunzhi, coumoxystrobin, enoxastrobin, flufenoxystrobin, jiaxiangjunzhi, picoxystrobin, and pyraoxystrobin; methoxycarbanilate strobilurin fungicides selected from pyraclostrobin, pyrametostrobin, and triclopyricarb, methoxyiminoacetamide strobilurin fungicides selected from dimoxystrobin, fenaminstrobin, metominostrobin, and orysastrobin; methoxyiminoacetate strobilurin fungicides selected from kresoxim-methyl, and trifloxystrobin; or a combination thereof.

According to an embodiment, the strobilurin fungicide comprises azoxystrobin, kresoxim-methyl, picoxystrobin, pyraclostrobin, trifloxystrobin, or a combination thereof. The succinate dehydrogenase inhibitor, for example, includes benzanilide fungicides such as benodanil, flutolanil, mebenil, mepronil, and salicylanilide, tecloftalam; benzamide fungicides such as benzohydroxamic acid, fluopicolide, fluopimomide, fluopyram, tioxymid, trichlamide, zarilamid, and zoxamide; oxathiin fungicides such as carboxin and oxycarboxin; thiazole fungicides such as dichlobentiazox, ethaboxam, fluoxapiprolin, isotianil, metsulfovax, octhilinone, oxathiapiprolin, thiabendazole, and thifluzamide; pyrazolecarboxamide fungicides such as benzovindiflupyr, bixafen, fluindapyr, fluxapyroxad, furametpyr, isopyrazam, penflufen, penthiopyrad, pydiflumetofen, pyrapropoyne, sedaxane, fluxapyroxad isopyrazam, and boscalid; anilide fungicides such as benalaxyl, benalaxyl-M, bixafen, boscalid, carboxin, fenhexamid, fluxapyroxad, isotianil, metalaxyl, metalaxyl-M, metsulfovax, ofurace, oxadixyl, oxycarboxin, penflufen, pyracarbolid, pyraziflumid, sedaxane, thifluzamide, tiadinil, and vanguard; pyrazolecarboxamide fungicides such as benzovindiflupyr, bixafen, fluindapyr, fluxapyroxad, furametpyr, isopyrazam, penflufen, penthiopyrad, pydiflumetofen, pyrapropoyne, and sedaxane; or a combination thereof.

In an embodiment, the succinate dehydrogenase inhibitor comprises benzovindiflupyr, bixafen, fluxapyroxad, furametpyr, isopyrazam, penflufen, penthiopyrad, sedaxane, boscalid, thifluzamide, carboxin, oxycarboxin, fenfuram, fluopyram, isofetamid, benodanil, flutolanilmepronil or a combination thereof.

In an embodiment, the additional fungicide comprises a phenylpyrroles fungicide.

The phenylpyrroles fungicide comprises fenpiclonil, fludioxonil or a combination thereof.

In an embodiment, the additional fungicide comprises metrafenone, amisulbrom, isotianil, fluopicolide, fenpyrazamine, valifenalate, mandipropamid, penflufen, bixafen, fluopyram, fluxapyroxad, isopyrazam, penthiopyrad, pyriofenone, sedaxane, pydiflumetofen, dichlobentiazox, isoflucypram, fenpicoxamid, florylpicoxamid, fluoxapiprolin, mefentrifluconazole, ipfentrifluconazole, metyltetraprole, inpyrfluxam, quinofumelin, oxathiapiprolin, fluindapyr, dipymetitrone, pyridachlometyl, benzovindiflupyr, orysastrobin, ametoctradin, flutianil, pyraziflumid, coumoxystrobin, pyribencarb, tebufloquin, isofetamid, tolprocarb, mandestrobin, picarbutrazox or a combination thereof.

In an embodiment, the additional fungicide comprises azoxystrobin, bifaxen, spiroxamine, tebuconazole, fluoxastrobin, trifloxystrobin, metominostrobin, fluindapyr or a combination thereof.

In an embodiment the additional fungicide for combination comprises fludioxonil.

In an embodiment, the agrochemical fungicidal composition comprises:
a) prothioconazole or a salt, an ester, an isomer thereof; and
b) an anionic surfactant.

In an embodiment, the agrochemical fungicidal composition comprises:
a) prothioconazole or a salt, an ester, an isomer thereof; and
b) an anionic surfactant; and
c) fludioxonil.

In an embodiment the additional fungicide for combination comprises fludioxonil.

In an embodiment, the agrochemical fungicidal composition comprises:
a) triticonazole or a salt, an ester, an isomer thereof; and
b) an anionic surfactant.

In an embodiment the additional fungicide for combination comprises fludioxonil.

In an embodiment, the agrochemical fungicidal composition comprises:
a) triticonazole or a salt, an ester, an isomer thereof;
b) an anionic surfactant; and
c) fludioxonil.

In an embodiment, the anionic surfactant comprises an alkyl ether sulphate, an alkyl ether phosphate, or a combination thereof. In an embodiment, the agrochemical fungicidal composition further comprises at least one agrochemically acceptable excipient.

In a preferred embodiment said additional fungicide is azoxystrobin.

In an embodiment the agrochemical fungicidal composition comprises:
a) prothioconazole a salt, an ester, an isomer thereof;
b) an anionic surfactant comprising an alkyl ether sulphate, an alkyl ether phosphate, or a combination thereof; and
c) a strobilurin fungicide.

The agrochemical fungicidal compositions of the present disclosure may further comprise one or more of adjuvants including but not limited to dispersants, wetting agents, fillers, surfactants, anticaking agents, pH-regulating agents, preservatives, biocides, antifoaming agents, colorants, water and other formulation aids.

Suitable liquid carriers that may be employed include water, a water miscible solvent, or an organic solvent. The water-miscible solvent as used herein refers to a solvent which is miscible with water, i.e., water and the solvent do not separate into different layers. Suitable examples include glycols, such as propylene glycol, ethylene glycol, diethylene glycol, 1,2-propylene glycol, and tripropylene glycol; alcohols, such as methanol, ethanol, isopropanol, and n-propanol. Combinations of water-miscible solvents may also be used. In an embodiment, the water-miscible solvent is a glycol, and in particular, a 1,2-propylene glycol.

Anti-freezing agents include glycerin, ethylene glycol, propylene glycol, or combination thereof. The anti-freezing agent is included in a concentration of from about 0.5% to about 10% by weight, based on the total weight of the composition.

The properties of the fungicidal composition disclosed herein remain stable during storage. For example, there is substantially no separation of the liquid phase (syneresis) and solid phase (sedimentation) in the fungicidal composition following storage at temperatures of −10° C., 25° C., and/or 54° C.

In an embodiment, syneresis of the fungicidal composition is less than 10% following storage for 2 weeks at 54° C.

In an embodiment, syneresis of the fungicidal composition is less than 5% following storage for 2 weeks at 54° C.

In an embodiment, syneresis of the fungicidal composition is less than 1% following storage for 2 weeks at 54° C.

In an embodiment, syneresis of the fungicidal composition is 0% (i.e., there is no syneresis) following storage for 2 weeks at 54° C.

In an embodiment, syneresis of the fungicidal composition is less than 10% for 6 months at 0° C. or at 25° C.

In an embodiment, syneresis of the fungicidal composition is less than 5% following storage for 6 months at 0° C. or at 25° C.

In an embodiment, syneresis of the fungicidal composition is less than 1% following storage for 6 months at 0° C. or at 25° C.

In an embodiment, syneresis of the fungicidal composition is 0% (i.e., there is no syneresis) following storage for 6 months at 0° C. or at 25° C.

In an embodiment, there is substantially no sedimentation of the fungicidal composition following storage for 2 weeks at −10° C., at 25° C. and at 54° C.

In an embodiment, there is substantially no sedimentation of the fungicidal composition following storage for 6 months at −10° C., at 25° C. and at 54° C.

In an embodiment, there is substantially no sedimentation of the fungicidal composition following storage for 12 months at −10° C., at 25° C. and at 54° C.

In an embodiment, sedimentation of the fungicidal composition is 0% following storage for 2 weeks at −10° C., at 25° C., and at 54° C.

In an embodiment, the pH of the fungicidal composition is 7.0 to 9.5 prior to dilution of the fungicidal composition.

In an embodiment, the pH of the fungicidal composition is 7.0 to 9.0 prior to dilution of the fungicidal composition.

In an embodiment, the pH of the fungicidal composition is 7.5 to 9.5 prior to dilution of the fungicidal composition.

In an embodiment, the pH of a fungicidal composition comprising triticonazole is 7.0 to 9.0 prior to dilution of the fungicidal composition.

In an embodiment, the pH of a fungicidal composition comprising triticonazole is 7.5 to 9.5 prior to dilution of the fungicidal composition.

In an embodiment, the pH of a fungicidal composition comprising prothioconazole is 7.5 to 9.5 prior to dilution of the fungicidal composition.

In an embodiment, for the pH of a fungicidal composition comprising prothioconazole is 7.0 to 9.0.

In an embodiment, for the fungicidal composition has a CP52 viscosity as measured using a Brookfield viscometer for 2 mins at 6 rpm of about 150 centipoise (cP) to about 400 centipoise, or about 200 centipoise (cP) to about 400 centipoise, or about 150 centipoise to about 350 centipoise.

In an embodiment, for the fungicidal composition has a CP52 viscosity as measured using a Brookfield viscometer for 2 mins at 6 rpm of about 200 centipoise (cP) to about 400 centipoise.

In an embodiment, for the fungicidal composition has a CP52 viscosity as measured using a Brookfield viscometer for 2 mins at 6 rpm of about 150 centipoise (cP) to about 350 centipoise.

In an embodiment, the fungicidal composition comprising prothioconazole has a CP52 viscosity as measured using a Brookfield viscometer for 2 mins at 6 rpm of about 200 cP to about 400 cP.

In an embodiment, the fungicidal composition comprising triticonazole has a CP52 viscosity as measured using a Brookfield viscometer for 2 mins at 6 rpm of about 150 cP to about 350 cP.

In an embodiment, the fungicidal compositions has a CP52 viscosity as measured using a Brookfield viscometer for 2 mins at 60 rpm of about 40 to about 100 centipoise, or about 40 to about 80 centipoise, or about 50 to about 100 centipoise.

In an embodiment, the fungicidal compositions has a CP52 viscosity as measured using a Brookfield viscometer for 2 mins at 60 rpm of about 40 to about 80 centipoise.

In an embodiment, the fungicidal compositions has a CP52 viscosity as measured using a Brookfield viscometer for 2 mins at 60 rpm of about 50 to about 100 centipoise.

In an embodiment, the fungicidal composition comprising prothioconazole has a CP52 viscosity as measured using a Brookfield viscometer for 2 mins at 60 rpm of about 50 centipoise to about 100 centipoise, or about 40 centipoise to about 80 centipoise.

In an embodiment, the fungicidal compositions disclosed herein have a D50 particle size of less than or equal to about 3 micrometers (μm).

In an embodiment, for the fungicidal compositions disclosed herein have a D90 particle size of less than or equal to about 10 μm, or less than or equal to 7 microns.

For viscosity measurement, cone and plate assembly of Brookfield viscometer DV3T was used. Sample size required for measurement was 0.5 ml and the measurement was done at 20° C.

For particle size measurement of the compositions, malvern mastersizer 3000 instrument with Hydro LV, dispersion accessory with 2400 rpm stirrer speed was used.

For syneresis measurement of the compositions, a ruler was used to measure any bleed/syneresis present and it rounded off to the nearest mm. This was calculated as a percentage of the total amount of product to the nearest whole percent. (Example—7 mm bleed in 42 mm of product is 7/42×100%=16.66, i.e. 17% bleed).

For sediment measurement of the compositions, a dipping implement (spatula) was inserted to the bottom of the container to test for the presence of sedimentation and a note of any findings was made (eg, hard sticky sediment or soft loose sediment).

For pH neat measurement of the compositions, 50 ml sample was transferred into a 100 ml and pH electrode was immersed into the liquid and the PH was measured without stirring. pH value is recorded again after 1 minute again. If the pH value changed more than 0.1 pH unit during this time, then pH was recorded again after 10 mins after immersion of the electrode.

In an embodiment, the disclosed fungicidal compositions are in the form of a soluble (liquid) concentrate, a suspension concentrate (SC), an oil in water emulsion, a water in oil emulsion, an emulsifiable concentrate (EC), a capsule suspension (CS), a ZC formulations (e.g., suspension of fine particles of an SC combined with a capsule suspension in an aqueous phase), an oil dispersion, a flowable suspension, or other known formulation types.

In an embodiment the disclosed fungicidal composition is formulated in the form of a suspension concentrate.

In an embodiment, suitable antifoaming agents or defoamers may be employed to prevent the generation of any unwanted foam during the manufacturing of a suspension concentrate (SC) composition. The antifoaming agent comprises silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols, or a combination thereof.

In an embodiment, thickeners/viscosity modifiers that may be used include silicates such meal silicates, sodium carboxymethyl cellulose, methyl cellulose, ethyl cellulose, polyvinylalcohol, polyvinylpyrrolidone, sodium alginate, Sodium poly acrylate, xanthan gum, welan gum, gum arabic, montmorillonite, lignosulfonates, hydroxy methyl cellulose, dextrin, starch, or a combination thereof.

In an embodiment the disclosed fungicidal composition is formulated in the form of a flowable suspension.

The fungicidal compositions of the present disclosure are used in agrochemical methods, and even when stored for a relatively long period, exhibit no phase separation. In addition, the fungicidal compositions have a high degree of chemical stability following storage for at least 2 weeks at various temperatures.

In the fungicidal composition for controlling plant diseases of the present disclosure, a total amount of the fungicidal active compound (e.g. conazole fungicide) or a salt, an ester, an isomer thereof, is in the range of about 0.1% to about 99% by weight, or about 0.2% to about 90% by weight, or about 1% to about 80% by weight, based on the total weight of the composition.

The fungicidal composition for controlling plant diseases of the present disclosure can be used in areas intended for agricultural use (agricultural locus) such as fields, wet paddy fields, dry paddy fields, lawns, orchards. The fungicidal composition may also be used in areas not intended for agricultural use (non-agricultural land).

The fungicidal compositions according to the present disclosure are useful in combating, preventing or controlling phytopathogenic diseases cause by a phytopathogen (a fungus). The fungicidal composition may be applied to the phytopathogen, to the locus including the phytopathogen, to a plant susceptible to attack by the phytopathogen, or to propagation material of a plant susceptible to attack by the phytopathogen.

In an embodiment, a method of controlling fungi in a plant comprises applying to the plant, a propagation material thereof, or a locus at which the plant is growing or intended to be grown, an effective amount of the agrochemical fungicidal composition.

In another embodiment, provided is, use for controlling plant pests, of an agrochemical composition comprising:
a) at least one conazole fungicide or a salt, an ester, an isomer thereof; and
b) an anionic surfactant.

In another embodiment, provided is, use for applying to the plant, a propagation material thereof, or a locus at which the plant is growing or intended to be grown, an effective amount of the agrochemical fungicidal composition, of an agrochemical composition comprising:
a) at least one conazole fungicide or a salt, an ester, an isomer thereof; and
b) an anionic surfactant for controlling plant pests.

In another embodiment, provided is, use for applying to the plant, a propagation material thereof, or a locus at which the plant is growing or intended to be grown, an effective amount of the agrochemical fungicidal composition, of an agrochemical composition comprising:
a) at least one conazole fungicide or a salt, an ester, an isomer thereof; and
b) an anionic surfactant, wherein the agrochemical fungicidal composition is applied at a rate in the range of about 0.001 ml/100 kg to about 1000 ml/100 kg based on weight of the seed.

The ingredients of the present disclosure may be sold as a pre-mixed composition. Alternatively, they may be provided individually as separate parts of a kit and may be mixed together before spraying. In a separate embodiment, at least one adjuvant may also be included with the kit and mixed together with the conazole fungicides.

The composition of the present disclosure maybe applied simultaneously as a tank mix or formulation of the conazole fungicide and additional fungicides may be applied sequentially. Alternatively, the application may be a post-emergent application. The application may be made to the soil before emergence of the plants, either pre-planting or post-planting. The application may be made as a foliar spray at different timings during crop development, with either one or two applications early or late post-emergence.

The fungicidal compositions according to the present disclosure are effective for treating and/or preventing the following plant diseases caused by their respective phytopathogen, which include:

Disease in rice such as: Blast (Pyricularia Oryzae), Helminthosporium leaf spot (Cochliobolus miyabeanus), sheath blight (Rhizoctonia solani), and bakanae disease (Gibberella fujikuroi).

Diseases in wheat such as: powdery mildew (Erysiphe graminis), Fusariuin head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch 3h, (Mycosphaerella graminicola), glume blotch (Stagonospora nodosum), septoria, and yellow spot (Pyrenophora tritici-repentis).

Diseases of barley such as: powdery mildew (Erysiphe graminis), Fusarium head blight (Fusarium graminearum, F. avenacerum, F. culmorum, Microdochium nivale), rust—(Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn such as: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).

Diseases of citrus such as: melanose (Diaporthe citri), scab (Elsinoe fawcetti), penicillium rot (Penicillium digitatum, P. italicum), and brown rot (Phytophthora parasitica, Phytophthora citrophthora).

Diseases of apple such as: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear such as: scab (Venturia nashicola, V. pirina), powdery mildew, black spot (Alternaria alternata Japanese pear pathotype), rust (Gymnosporangium 3h, haraeanum), and phytophthora fruit rot (Phytophtora cactorum).

Diseases of peach such as: brown rot (Monilinia fructicola), powdery mildew, scab (Cladosporium carpophilum), and phomopsis rot (Phomopsis sp.).

Diseases of grape such as: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon such as: anthracnose (Gloeosporium kaki), and leaf spot (Cercospora kaki, Mycosphaerella nawae).

Diseases of gourd such as: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis) tA Phytophthora rot (Phytophthora sp.), and damping-off (Pythium sp.).

Diseases of tomato such as: early blight (Alternaria solani), leaf mold (Cladosporium fulvum), and late blight (Phytophthora infestans).

Diseases of eggplant such as: brown spot (Phomopsis vexans), and powdery mildew 3 (Erysiphe cichoracearum)

Diseases of cruciferous vegetables: Alternaria leaf spot (Alternaria japonica), white spot (Cercosporella brassicae), clubroot (Plasmodiophora brassicae), and downy mildew (Peronospora parasitica).

Diseases of onion such as: rust (Puccinia allii), and downy mildew (Peronospora destructor).

Diseases of soybean such as: purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and Rhizoctonia damping-off (Rhizoctonia solani).

Diseases of kidney bean such as: anthracnose (Colletotrichum lindemthianum).

Diseases of peanut such as: leaf spot (Cercospora personata), brown leaf spot (Cercospora arachidicola) and southern blight (Sclerotium rolfsii).

Diseases of garden pea such as: powdery mildew (Erysiphe pisi), and root rot (Fusarium solani f. sp. pisi).

Diseases of potato such as: early blight (Alternaria solani), late blight (Phytophthora tA infestans), pink rot (Phytophthora erythroseptica), and powdery scab (Spongospora subterranean f. sp. subterranea).

Diseases of strawberry such as: powdery mildew (Sphaerotheca humuli), and anthracnose (Glomerella cingulata).

Diseases of tea such as: net blister blight (Exobasidium reticulatum), white scab (Elsinoe 3 leucospila), gray blight (Pestalotiopsis sp.), and anthracnose (Colletotrichumtheae sinensis).

Diseases of tobacco such as: brown spot (Alternaria longipes), powdery mildew (Erysiphe cichoracearum), anthracnose (Colletotrichum tabacum), downy mildew 4h, (Peronospora tabacina), and black shank (Phytophthora nicotianae).

Diseases of rapeseed such as: sclerotinia rot (Sclerotinia sclerotiorum), and Rhizoctonia damping-off (Rhizoctonia solani).

Diseases of cotton such as: Rhizoctonia damping-off (Rhizoctonia solani).

Diseases of sugar beat such as: Cercospora leaf spot (Cercospora beticola), leaf blight (Thanatephorus cucumeris), Root rot (Thanatephorus cucumeris), and Aphanomyces root rot (Aphanomyces cochlioides).

Diseases of rose such as: black spot (Diplocarpon rosae), powdery mildew (Sphaerotheca pannosa), and downy mildew (Peronospora sparsa).

Diseases of chrysanthemum and asteraceous plants such as: downy mildew (Bremia lactucae), leaf blight (Septoria chrysanthemi-indici), and white rust (Puccinia horiana).

Diseases of various groups such as: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish such as: Alternaria leaf spot (Alternaria brassicicola).

Diseases of turfgrass such as: dollar spot (Sclerotinia homeocarpa), and brown patch and large patch (Rhizoctonia solani).

Disease of banana such as: Black sigatoka (Mycosphaerella fijiensis), Yellow sigatoka 4h, (Mycosphaerella musicola).

Disease of sunflower such as: downy mildew (Plasmopara halstedii).

Seed diseases or diseases in the early stages of the growth of various plants caused for example by Aspergillus spp., Penicillium sp.p., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants caused by Polymyxa spp. or Olpidium spp. and so on.

Examples of plants which may be treated with disclosed fungicidal compositions include brassicas, such as broccoli, Chinese broccoli, Brussels sprouts, cauliflower, Cavalo broccoli, kohlrabi, cabbage, Chinese cabbage and Chinese mustard cabbage; cilantro; coriander; corn; cucurbits, such as chayote; Chinese waxgourd, citron melon, cucumber, gherkin, gourd; muskmelons such as cantaloupe, casaba, crenshaw melon, golden pershaw melon, honeydew melon, honey balls, mango melon, Persian melon, pineapple melon, Santa Claus melon, snake melon and watermelon; squashes such as pumpkins, summer squash, and winter squash; dried beans and peas, including field bean, kidney bean, lima bean, pinto bean, navy bean, tepary bean, adzuki bean, blackeyed pea, catjang, cowpea, crowder pea, moth bean, mung bean, rice bean, southern pea, urd bean, broad bean, chickpea, guar, lablab bean, lentil, pea, field pea and pigeon pea; eggplant; lettuce; leafy brassicas/turnip greens including broccoli raab, bok Choy, collards, kale, mizuna, mustard spinach, rape greens and turnip greens; okra; peppers; soybeans; spinach; succulent peas and beans including pea, dwarf pea, edible-pod pea, English pea, garden pea, green pea, snow pea, sugar snap pea, pigeon pea, bean, broadbean, lima bean, runner bean, snap bean, wax bean, asparagus bean, yardlong bean, jackbean and sword bean; tobacco; tomatoes; and tuberous and corm vegetables including potato, sweet potato, arracacha, arrowroot, Chinese artichoke, Jerusalem artichoke, edible canna, cassava, chayote, chufa, dasheen, ginger, leren, tanier, turmer, yam bean, and true yam.

In an embodiment, the plant propagation material may be a seed.

In an embodiment, the present disclosure provides a method of controlling fungi comprising applying the fungicidal composition to a locus at which the plant is growing or is intended to be grown.

In an embodiment, the present disclosure provides a method for treatment of plant seeds wherein the method comprises applying the fungicidal composition to the plant seeds in need of treatment.

In an embodiment the method of treating a plant comprises treating plant seeds with the disclosed fungicidal composition. In the treatment of a plant seed, the application rate of the fungicidal composition is in the range from about 0.001 to about 1000 ml/100 kg plant seed, or about 0.1 to about 500 ml/100 kg of plant seed. The amount of active ingredient applied, based on the application rates, is generally in the range of about 0.005 to about 1000 grams active ingredient per 100 grams of seed (g a.i./100 kg of seed, or about 0.1 to about 50 g a.i./100 kg of seed.

In an embodiment, the fungicidal composition of the present disclosure is applied to seeds and/or other plant propagation material or transplanted saplings using known application methods.

In an embodiment, the fungicidal compositions of present disclosure may be applied to the locus of the plant on one or more occasions during the growth of the plant. It can be applied to the locus before the seed is sown, during the sowing of the seed, pre-emergence of the plant and/or post-emergence of the plant. The fungicidal composition can also be applied while the plant is being grown in a green house and applied one or more times again, after transplantation. The fungicidal composition can also be used for controlling soil borne diseases. The soil may, for example, be treated directly, prior to transplantation, at the time of transplantation and/or after the transplantation. The fungicidal composition can also be applied via any suitable method which ensures that the active agent in the fungicidal composition penetrates the soil, for example, in nursery tray application, in furrow application, soil drenching, soil injection, drip irrigation, application through sprinklers or central pivot, and incorporation into soil (broad cast or in band).

The treatment the plants and/or plant propagation material with the fungicidal composition is carried out by direct application of the fungicidal composition to the plant or plant propagation material, or by application of the fungicidal composition to their surroundings, habitat, or storage space using customary treatment methods, such as for example dipping, spraying, atomizing, irrigating, evaporating, dusting, fogging, broadcasting, foaming, painting, spreading-on, watering (drenching), and/or drip irrigating. In the case of plant propagation material, and in particular in the case of plant seeds, the fungicidal composition can be applied as a powder for dry seed treatment, a solution for wet seed treatment, a water-soluble powder for slurry treatment, and/or by incrusting, to coat the plant seeds with one or more layers.

It is furthermore possible to apply the fungicidal composition, alone or in combination with an additional active(s) by the ultra-low volume method, or by injection directly into the soil.

The rate and frequency of application of the fungicidal composition may vary widely and depends on the intended use, the specific active agents included in the fungicidal composition, the nature of the soil, the method of application (pre- or post-emergence, etc.), the type of plant and/or plant propagation material, the prevailing climate conditions, as well as other factors governed by the method of application, the time of application and the target plant.

In an embodiment, when employed in plant protection, the amount of conazole fungicide applied depends upon the desired effect to be achieved.

In an embodiment, the amount of conazole fungicide applied is from about 0.001 to about 10 kilograms per hectare (kg/ha).

In an embodiment, the amount of conazole fungicide applied is from about 0.001 to 5 kg/ha.

In an embodiment, the amount of conazole fungicide applied is from about 0.001 to about 2 kg per ha.

In an embodiment, the amount of conazole fungicide applied is from 0.005 to 1 kg per ha, or from about 0.005 to 0.5 kg per ha.

The rates of application of the fungicidal composition may vary, according to type of crop to be treated, the specific active ingredient(s) (e.g., conazole fungicide), the number of active ingredients, and the type of plant propagation material, but is such that the active ingredient(s) are applied in an effective amount to provide the desired action (such as disease or pest control) and their effectiveness can be measured by suitable testing.

In an embodiment, the plant seed treated with fungicidal composition comprises soybean, corn, cotton, wheat, barley, rye, triticale, oats, grass, or a combination thereof.

These and other advantages of the disclosure may become more apparent from the examples set forth herein below. These examples are provided merely as illustrations of the disclosure and are not intended to be construed as a limitation thereof.

### EXAMPLES

### Example 1 (Working Example)

The materials in Table 1 were used to prepare a flowable concentrate for seed treatment (FS) including the fungicide prothioconazole (100 g/l FS).

TABLE 1

| Ingredient | % w/w |
|---|---|
| Prothioconazole | 9.54 |
| Propylene Glycol | 7.00 |
| Sodium isotridecyl ether (20EO) sulfate | 2.00 |
| Sodium salt of naphthalene sulfonate condensate | 1.00 |
| Pigment Red 112 | 8.00 |
| Rapeseed oil | 10.00 |
| Water | Q.S. |
| Total | 100 |

Process: The above formulation including the materials shown in Table 1 was made via a milling process. All of the ingredients in their designated quantities were mixed and the mixture was milled in a wet bead mill to obtain a D50 particle size of <3 micrometres (μm) and a D90 particle size of <7 μm. The milled mixture was then combined (mixed) with water under high shear to obtain the desired formulation.

### Example 2 (Working Example)

The materials in Table 2 were used to prepare a composition including the fungicides prothioconazole (100 g/L)+fludioxonil (50 g/L).

TABLE 2

| Ingredient | % w/w |
|---|---|
| Prothioconazole | 9.54 |
| Fludioxonil | 4.72 |
| Propylene glycol | 7.00 |
| Potassium isotridecyl ether phosphate | 2.00 |
| Sodium salt of naphthalene sulfonate condensate | 1.00 |
| Pigment Red 112 | 8.00 |
| Rapeseed Oil | 10.00 |
| Water | Q.S. |
| Total | 100 |

The composition of Example 2 was prepared using the process described in example 1.

### Example 3 (Working Example)

The materials in Table 3 were used to prepare a composition including the fungicides prothioconazole (100 g/L) and+fludioxonil (50 g/L).

TABLE 3

| Ingredient | % w/w |
|---|---|
| Prothioconazole | 9.54 |
| Fludioxonil | 4.72 |
| Propylene glycol | 7.00 |
| Sodium isotridecyl ether (20EO) sulfate | 2.00 |
| Sodium salt of naphthalene sulfonate condensate | 1.00 |
| Pigment Red 112 | 18.5 |
| Rapeseed Oil | 10.00 |
| Water | Q.S. |
| Total | 100 |

The composition of Example 3 was prepared using the process described in example 1.

### Example 4 (Working Example)

The materials in Table 4 were used to prepare a FS composition including the fungicide triticonazole (50 g/L FS).

TABLE 4

| Ingredient | % w/w |
|---|---|
| Triticonazole | 4.81 |
| Propylene Glycol | 7.00 |
| Potassium isotridecyl ether phosphate | 2.00 |
| Sodium salt of naphthalene sulfonate condensate | 1.00 |
| Pigment Red 112 | 8.00 |
| Rapeseed Oil | 10.00 |
| Water | Q.S. |
| Total | 100 |

The composition of Example 4 was prepared using the process described in Example 1.

### Example 5 (Comparative Example)

The materials in Table 5 were used to prepare a comparative composition including the fungicide prothioconazole (100 g/L).

TABLE 5

| Ingredient | % w/w |
|---|---|
| Prothioconazole tech (99%) | 9.54 |
| Polyalkylene glycol ether polymeric emulsifier | 1.50 |
| Polymethyl methacrylate-polyethylene glycol graft copolymer | 1.00 |
| Non-ionic aqueous emulsion based on polydimethylsiloxane oil | 0.10 |
| 20% aqueous solution of 1,2-benzisothiazolin-3-one in | 0.10 |
| dipropylene glycol | |
| Pigment Red 48:2 | 8.00 |
| White Mineral Oil | 7.00 |
| Xanthan Gum | 0.20 |
| Propylene Glycol | 7.00 |
| Water | q.s. |

The composition of Example 5 was prepared using the process described in Example 1.

### Example 6 (Comparative Example)

The materials in Table 6 were used to prepare a comparative composition including the fungicide prothioconazole (100 g/L).

TABLE 6

| Ingredient | % w/w |
|---|---|
| Prothioconazole tech (99%) | 9.54 |
| Fludioxonil | 4.72 |
| Polyalkylene glycol ether polymeric emulsifier | 1.50 |
| Polymethyl methacrylate-polyethylene glycol graft copolymer | 1.00 |
| Non-ionic aqueous emulsion based on polydimethylsiloxane oil | 0.10 |
| 20% aqueous solution of 1,2-benzisothiazolin-3-one in | 0.10 |
| dipropylene glycol | |
| Pigment Red 48:2 | 8.00 |
| White Mineral Oil | 7.00 |
| Xanthan Gum | 0.20 |
| Propylene Glycol | 7.00 |
| Water | q.s. |

The composition of Example 6 was prepared using the process described in Example 1.

### Stability Test

The agrochemical compositions of Examples 1-6 were tested for dispersion stability of the active ingredients, particle size, pH, appearance, chemical analysis, microscopic appearance, persistent foam, suspensibility, pourability, viscosity, and general stability of the composition. The results are shown in Tables 7-12 below.

As shown in below, working examples are stable for 2 weeks and up to 12 months upon visual observation at ambient temperature, low temperature (e.g., 0° C. or −10° C.), and under accelerated heat at 54° C.

TABLE 7
Example 1

| Interval | Initial | 2 weeks | | |
|---|---|---|---|---|
| Temp (° C.) | N/A | −10 | 25 | 54 |
| Syneresis (%) | 0 | 0 | 0 | 0 |
| Sediment (Y/N) | N | N | N | N |
| pH neat | 8.3 | 8.2 | 8.2 | 8 |
| CP52 - 2 mins at 6 rpm (cP) | 276 | 273 | 257 | 278 |
| CP52 -2 mins at 60 rpm (cP) | 64 | 63 | 60 | 64 |
| Particle Size D50 (μm) | 1.8 | 1.8 | 1.8 | 1.7 |
| Particle Size D90 (μm) | 4.5 | 4.3 | 4.4 | 4.1 |

| | |
|---|---|
| Microscopic appearance | Good dispersion with crystals |
| | and pigment particles <10 μm |

TABLE 8
Example 2

| Interval | Initial | 2 weeks | | |
|---|---|---|---|---|
| Temp(° C.) | N/A | −10 | 25 | 54 |
| Syneresis (%) | 0 | 0 | 0 | Trace - |
| | | | | reconstitutes |
| | | | | within 1 invert |
| Sediment (Y/N) | N | N | N | N |
| pH neat | 8.2 | 8 | 7.8 | 7.7 |
| CP52 - 2 mins at 6 rpm | 330 | 298 | 319 | 338 |
| (cP) | | | | |
| CP52 -2 mins at 60 rpm | 74 | 73 | 72 | 76 |
| (cP) | | | | |
| Particle Size D50 (μm) | 1.71 | 1.52 | 1.64 | 1.7 |
| Particle Size D90 (μm) | 5.89 | 4.96 | 5.69 | 6.52 |

| | |
|---|---|
| Microscopic appearance | Good dispersion with crystals and |
| | pigment particles all up to 10-20 μm |

Stability study of formulation example 3 composition:

TABLE 9
Example 3

| Interval | Initial | 2 weeks | | | |
|---|---|---|---|---|---|
| Temp (° C.) | N/A | −10 | 25 | T/C* | 54 |
| Syneresis (%) | 0 | 0 | 0 | 0 | Trace |
| Sediment (Y/N) | N | N | N | N | N |
| pH neat | 8.1 | 8.2 | 8.2 | 8.3 | 8.2 |
| CP52 - 2 mins at 6 rpm (cP) | 248 | 227 | 223 | 222 | 236 |
| CP52 -2 mins at 60 rpm (cP) | 67 | 60 | 60 | 60 | 66 |
| Particle Size D50 (μm) | 1.34 | 7.15 | 1.12 | 1.22 | 1.19 |
| Particle Size D590 (μm) | 5.73 | 7.56 | 6.4 | 5.7 | 6.08 |

| | |
|---|---|
| Microscopic appearance | Good dispersion. Majority of crystals <5 μm. |
| | Square crystals seen up to 25 μm, most <15 μm. |
| | Pigment aggregates mainly <5 μm |

T/C* denotes temperature cycling between 12° C. and 38° C.

TABLE 10
Example 4

| Interval | Initial | 6 Months | | 12 Months |
|---|---|---|---|---|
| Temp (° C.) | N/A | 0 | 25 | 25 |
| Syneresis (%) | 0 | 0.0 | 0.0 | 4.3 |
| Sediment (Y/N) | N | N | N | N |
| pH neat | 7.7 | 8.2 | 7.8 | 7.9 |
| CP52 - 2 mins at 6 rpm (cP) | 175 | 178 | 178 | 470 |
| CP52 -2 mins at 60 rpm (cP) | 44 | 44 | 66 | 112 |
| Particle Size D50 (um) | 2.33 | 2.23 | 2.21 | 2.27 |
| Particle Size D90 (um) | 6.2 | 6.38 | 6.57 | 6.13 |
| Microscopic appearance | Majority | Well dispersed, | Well dispersed, | Good dispersion. |
| | of crystals | crystals, | crystals, | Majority of |
| | and pigment | mostly <5 μm, | mostly <5 μm, | crystals <5 μm. |
| | particles ≤15 | up to 10 μm | some <10 μm | Few pigment |
| | μm. Some larger | | up to 50 μm. | aggregates - |
| | up to 20 μm. | | | Generally |
| | Some small | | | small, <5 μm. |
| | oil droplets | | | |
| | present ≤5 μm | | | |

TABLE 11
Example 5 (Comparative)

| Interval | Initial | 2 weeks | | |
|---|---|---|---|---|
| Temp(° C.) | N/A | -10 | T/C* | 54 |
| Syneresis (%) | 0 | 0 | 0 | 0 |
| Sediment (Y/N) | N | N | N | N |
| pH neat | 8.2 | 7.7 | 7.7 | 7.5 |
| CP52 - 2 mins at 6 rpm (cP) | 262 | 262 | 296 | 1242 |
| CP52 -2 mins at 60 rpm (cP) | 67 | 68 | 71 | Off Scale* |
| Particle Size D30 (μm) | 2.73 | 2.96 | 2.74 | 11.4 |
| Particle Size D90 (μm) | 7.14 | 8.25 | 6.94 | 20.7 |

| | | | |
|---|---|---|---|
| Microscopic appearance | Good dispersion | Good dispersion | Good dispersion |
| | with some | with some | with some |
| | crystal <10 μm. | crystal <10 μm. | crystal <10 μm. |
| | Some pigment | Some pigment | Some pigment |
| | aggregates | aggregates | aggregates ~20 |
| | present. | present. | μm present. |

T/C* denotes temperature cycling between 12° C. and 38° C.
*Off scale means greater than 150 cps at 60 rpm

TABLE 12
Example 6 (Comparative)

| Interval | Initial | 2 weeks | | |
|---|---|---|---|---|
| Temp(° C.) | N/A | -10 | T/C* | 54 |
| Syneresis (%) | 0 | 0 | 0 | 0 |
| Sediment (Y/N) | N | N | N | N |
| pH neat | 8.2 | 8.1 | 8.1 | 8.0 |
| CP52 - 2 mins at 6 rpm (cP) | 245 | 197 | 203 | 1150 |
| CP52 -2 mins at 60 rpm (cP) | 64 | 58 | 58 | OS |
| Particle Size D50 (μm) | 2.5 | 2.83 | 2.46 | 10.6 |
| Particle Size D90 (μm) | 6.97 | 7.65 | 6.18 | 20.6 |
| Microscopic appearance | Good dispersion | Most crystals <10 | Good dispersion | Good dispersion |
| | with some crystals | μm, found up to | with some crystals | with some crystals |
| | present <10 μm. | 30 μm. Crystals | present <10 μm. | present <10 μm. |
| | There are also | frequently seen | There are also | There are also |
| | some small pigment | in small clusters. | some small pigment | some small pigment |
| | particles present. | Large amounts of | particles present. | particles present. |
| | | pigment aggregation. | | |

T/C* denotes temperature cycling between 12° C. and 38° C.

1. An agrochemical fungicidal composition comprising: a) at least one conazole fungicide or a salt, an ester, an isomer thereof; and b) an anionic surfactant.

2. The agrochemical fungicidal composition as claimed in claim 1, wherein the fungicidal composition is a liquid composition.

3. The agrochemical fungicidal composition as claimed in claim 1, wherein the at least one conazole fungicide comprises azaconazole, bromuconazole, cyproconazole, diclobutrazol, difenoconazole, diniconazole, diniconazole-M, epoxiconazole, etaconazole, fenbuconazole, fluconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, thiabendazole, triadimefon, triadimenol, triticonazole, uniconazole, uniconazole-P, or a salt, an ester, an isomer thereof, or a combination thereof.

4. The agrochemical fungicidal composition as claimed in claim 1, wherein the at least one conazole fungicide comprises prothioconazole or a salt, an ester, an isomer thereof.

5. The agrochemical fungicidal composition as claimed in claim 1, wherein the at least one conazole fungicide comprises triticonazole or a salt, an ester, an isomer thereof.

6. The agrochemical fungicidal composition as claimed in claim 1, wherein the anionic surfactant comprises an alkyl ether sulfate, an alkyl ether phosphate, a salt thereof, or a combination thereof.

7. The agrochemical fungicidal composition as claimed in claim 1, wherein the anionic surfactant comprises an alkylaryl ether sulfate, a polyarylphenol polyalkoxyether sulfate, a polyarylphenol polyalkoxyether phosphate, or a combination thereof.

8. The agrochemical fungicidal composition as claimed in claim 1, wherein the anionic surfactant comprises a sodium alkyl ether sulfate, a polyoxyalkylene alkylether sulfate, a polyoxyalkylene alkylaryl ether sulfate, an alkyl phosphate, or a combination thereof.

9. The agrochemical fungicidal composition as claimed in claim 8, wherein the alkyl phosphate comprises potassium isotridecyl ether phosphate, a potassium salt of tridecyl alcohol ether phosphate, a polyoxyalkylene alkyl phosphate, a polyoxyalkylene phenylether phosphate, or a combination thereof.

10. The agrochemical fungicidal composition as claimed in claim 1, wherein the anionic surfactant comprises an ethoxylated sodium isotridecyl ether sulfate having 20 ethylene oxide (EO) units, an ethoxylated C 12-14 ether sulfate having 7 EO units, potassium isotridecyl ether phosphate, or a combination thereof.

11. The agrochemical fungicidal composition as claimed in claim 1, wherein the composition comprises from about 0.1% to about 50% w/w of the conazole fungicide of the total weight of the agrochemical composition.

12. The agrochemical fungicidal composition as claimed in claim 1, wherein the composition comprises from about 0.1% by weight to about 99.9% by weight of the anionic surfactant.

13. The agrochemical fungicidal composition as claimed in claim 1, wherein the fungicidal composition comprises the at least one conazole fungicide compound and anionic surfactant in a weight ratio of about 1:10 to about 10:1.

14. The agrochemical fungicidal composition as claimed in claim 1, further comprising an additional fungicide.

15. A process of preparing an agrochemical fungicidal composition, comprising: obtaining a mixture of at least one conazole fungicide or a salt, an ester, an isomer thereof, an anionic surfactant, and optionally other adjuvants, milling the mixture; and combining the milled mixture with a solvent to obtain the agrochemical composition, wherein the agrochemical composition comprises: the at least one conazole fungicide or a salt, an ester, an isomer thereof; the anionic surfactant; and optionally the other adjuvants.

16. A method of controlling fungi in a plant comprising applying to the plant, a propagation material thereof, or a locus at which the plant is growing or intended to be grown, an effective amount of the agrochemical fungicidal composition of claim 1.

17. The method of controlling fungi as claimed in claim 16, wherein the propagation material comprises a plant seed.

18. The method of controlling fungi as claimed in claim 16, wherein the agrochemical fungicidal composition is applied at a rate in the range of about 0.001 ml/100 kg to about 1000 ml/100 kg based on weight of the seed.

19. (canceled)

20. (canceled)

21. (canceled)
